(19) United States
(12) Patent Application Publication
(10) Pub. No.: US 2014/0010276 A1
(43) Pub. Date: Jan. 9, 2014

(54) CIRCUIT AND METHOD FOR CLOCK DATA RECOVERY

(71) Applicant: NOVATEK MICROELECTRONICS CORP., Hsinchu (TW)

(72) Inventors: Chia-Hao HSU, Hsinchu City (TW); Yu-Hsing CHIANG, Hsinchu City (TW)

(21) Appl. No.: 13/935,868

(22) Filed: Jul. 5, 2013

(30) Foreign Application Priority Data
Jul. 6, 2012 (TW) 101124483

(51) Int. Cl. H04L 25/03

(52) U.S. Cl. CPC H04L 25/03949
USPC 375/233

(57) ABSTRACT

A clock data recovery circuit includes an equalizer, a multi-phase clock generator, a sampling and check unit, a signal edge detection unit and an adjusting unit. The equalizer performs an equalization on an incoming data signal. The multi-phase clock generator generates multiple clock signals and at least one pair of check signals. The sampling and check unit samples the incoming data signal according to the clock signals to obtain a sequence, and checks whether the sequence matches a predetermined pattern. If so, the signal edge detection unit controls the sampling and check unit to detect a transition between values of the sequence two on two based on the pair of check signals to obtain a detection value. The adjusting unit determines whether the transition is too early or too late according to the detection value, and adjusts the equalization on the incoming data signal according to the determination result.

This application claims the benefit of Taiwan application Serial No. 101124483, filed Jul. 6, 2012, the subject matter of which is incorporated herein by reference.

### BACKGROUND OF THE INVENTION

1. Field of the Invention

The invention relates to a circuit and method for clock data recovery.

2. Description of the Related Art

When high-speed transmission signals are propagated, not all frequency components are attenuated at a same level. High-frequency components generally attenuate at a greater level than low-frequency components, such that inter-symbol interference (ISI) effects are produced to lead to jittering of the transmission signals at ideal time points. In a conventional solution, equalization is performed to boost high-frequency components with a greater value than low-frequency components. However, as the conventional equalization method is performed jointly with a bang bang phase detector (BBPD) for determining edges of the transmission signals, such conventional solution is inapplicable to an equalizer structure that does not carry a BBPD.

### SUMMARY OF THE INVENTION

The invention is directed to a clock data recovery circuit and method for eliminating ISI effects.

According to a first aspect the present invention, a circuit for clock data recovery is provided. The circuit includes an equalizer, a multi-phase clock generator, a sampling and check unit, a signal edge detection unit and an adjusting unit. The equalizer performs an equalization on an incoming data signal. The multi-phase clock generator generates multiple clock signals and at least one pair of check signals. The sampling and check unit samples the incoming data signal according to the clock signals to obtain a sequence, and checks whether the sequence matches a predetermined pattern. When the sequence matches the predetermined pattern, the signal edge detection unit controls the sampling and check unit to correspondingly detect a transition between values of the sequence two on two based on the pair of check signals to obtain a detection value. The adjusting unit determines whether the transition between the values of the sequence is too early or too late according to the detection value, and adjusts the equalization on the incoming data signal according to the determination result.

According to a second aspect of the present invention, a method for clock data recovery for a clock data recovery circuit is provided. The clock data recovery circuit includes an equalizer, a multi-phase clock generator, a sampling and check unit, a signal edge detection unit and an adjusting unit. The method includes steps of: performing an equalization on an incoming data signal by the equalizer; generating multiple clock signals and at least one pair of check signals by the multi-phase clock generator; sampling the incoming data signal according to the clock signals to obtain a sequence and checking whether the sequence matches a predetermined pattern by the sampling and check unit; when the sequence matches the predetermined pattern, controlling the sampling and check unit to correspondingly detect a transition between values of the sequence two on two based on the pair of check signal to obtain a detection value by the signal edge detection unit; determining whether the transition between the value of the sequence is too early or too late according to the detection value, and controlling the equalizer to adjust the equalization on the incoming data signal according to the determination result by the adjusting unit.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a clock data recovery circuit according to an embodiment.

FIG. 2 is waveforms of clock signals and check signals according to an embodiment.

FIG. 3 is a schematic diagram of detecting a transition according to an embodiment.

FIG. 4A and FIG. 4B are schematic diagrams of detecting ISI according to an embodiment.

### DETAILED DESCRIPTION OF THE INVENTION

In a circuit and method for clock data recovery disclosed by the present invention, multiple clock signals and at least one pair of check signals are generated by a multi-phase clock generator to detect edges of an incoming data signal, so as to effectively eliminate inter-symbol interference (ISI) effects.

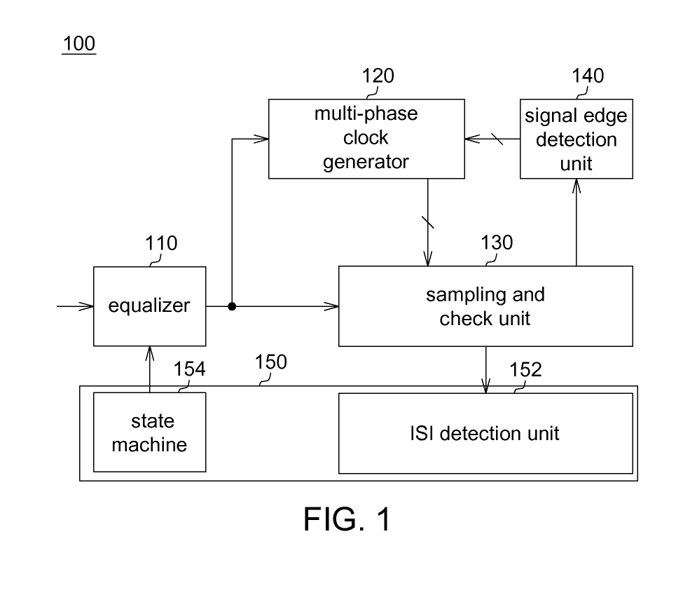

FIG. 1 shows a block diagram of a clock data recovery circuit according to an embodiment. A clock data recovery circuit 100 includes an equalizer 110, a multi-phase clock generator 120, a sampling and check unit 130, a signal edge detection unit 140, and an adjusting unit 150. The equalizer 110 performs an equalization on an incoming data signal. The equalized incoming signal is forwarded to the multi-phase clock generator 120 via a clock path, and the multi-phase clock generator 120 accordingly generates multiple clock signals and at least one pair of check signals. The clock signals are for sampling the incoming data signal, and the check signals correspond to edges of the data signal.

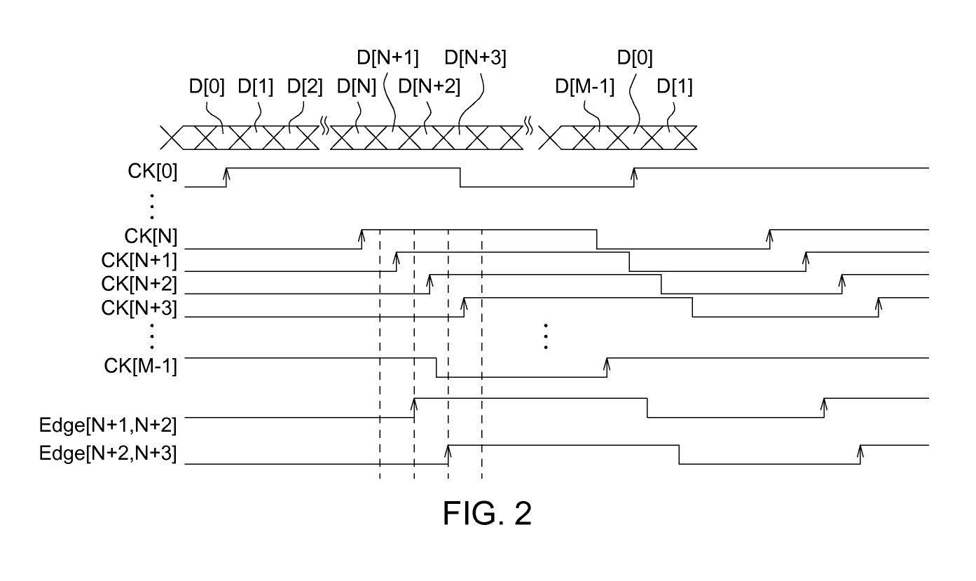

Assume that the multi-phase clock generator 120 generates an M number of clock signals and a pair of check signals, where M is a positive integer. FIG. 2 shows waveforms of clock signals and check signals according to an embodiment. The sampling and check unit 130 respectively samples data D[0] to D[M−1] of the incoming data signal according to the M number of clock signals CK[0] to CK[M−1] to obtain a sequence, and checks whether the sequence matches a predetermined pattern. For example, the predetermined pattern is several 1s followed by one 0, or several 0s followed by one 1, i.e., 1, 1, . . . , 1, 0, 1 or 0, 0, 0, . . . , 0, 1, 0.

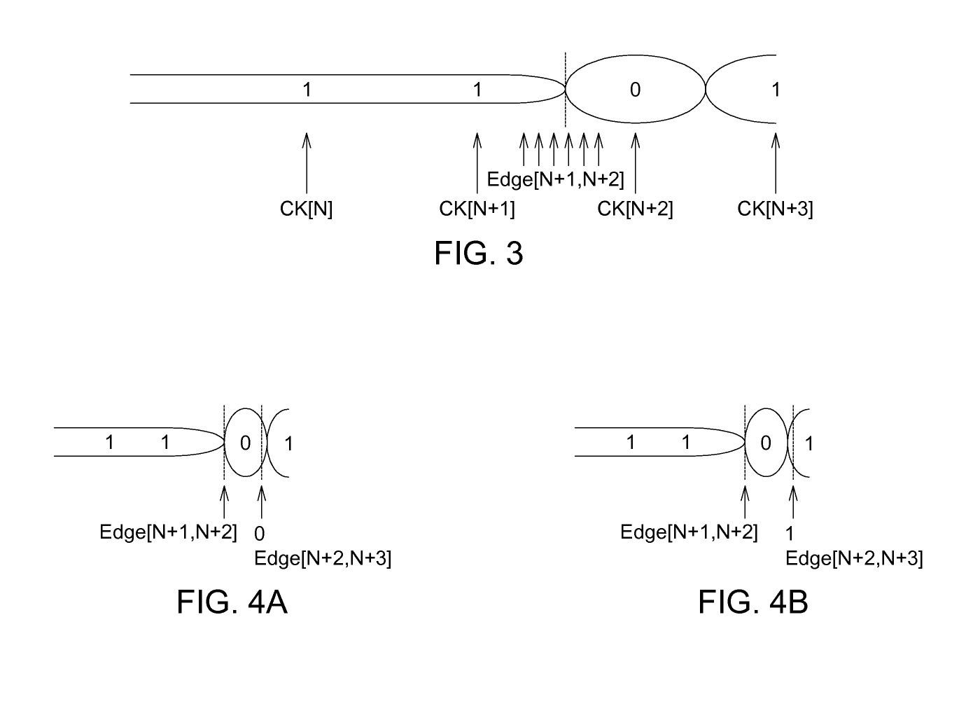

Each pair of check signals includes a first check signal and a second check signal. When the sequence matches the predetermined pattern, the signal edge detection unit 140 controls the sampling and check unit 130 to correspondingly detect a transition between values of the sequence two on two to obtain a detection value. FIG. 3 shows a schematic diagram of detecting a transition according to an embodiment. Referring to

FIGS. 2 and 3, assuming that a sequence 1, 1, 0, 1 obtained from four consecutive clock signals CK[N], CK[N+1], CK[N+2] and CK[N+3] matches the predetermined pattern, the first check signal and the second check signal respectively correspond to the edges between CK[N+1] and CK[N+2] and the edges between CK[N+2] and CK[N+3]. Accordingly, the first check signal and the second check signal are respectively denoted as Edge[N+1, N+2] and Edge[N+2, N+3].

In FIG. 3, the signal edge detection unit 140 substantially divides the first check signal Edge[N+1, N+2] into a K number of phases, where K is a positive integer. The signal edge detection unit 140 controls the sampling and check unit 130 to check and obtain that the value of the sequence converts from 1 to 0 at a Y^{th} phase of the first check signal Edge[N+1, N+2], and records a first check code Edgecode[N+1, N+2] as Y, where Y is a positive integer. The signal edge detection unit 140 further divides the second check signal Edge[N+2, N+3] into a K number of phases, and controls the sampling and check unit 130 to check whether the value of the sequence converts from 0 to 1 at a Y^{th} phase of the second check signal Edge[N+2, N+3] to determine a detection value.

The adjusting unit 150 determines whether the transition between the values of the sequence is too early or too late according to the detection value, and controls the equalizer 110 to adjust the equalization on the incoming data signal according to the determination result. In FIG. 1, for example, the adjusting unit 150 is implemented by an ISI detection unit 152 and a state machine 154. FIGS. 4A and 4B show schematic diagrams of detecting for ISI according to an embodiment.

From FIG. 4A, it is observed that the value of the sequence at the Y^{th} phase of the second check signal Edge[N+2, N+3], instead of converting from 0 to 1, stays at 0. Hence, the ISI detection unit 152 determines that the transition between the values of the sequence is too late according to detection value, i.e., over-damping has occurred. The state machine 154 is controlled by the determination result of the ISI detection unit 152 to output a state value to the equalizer 110 to adjust the equalization on the incoming data signal, such that the equalizer 110 reduces a gain for high-frequency components relative to that for low-frequency components.

From FIG. 4B, it is observed that the value of the sequence at the Y^{th} phase of the second check signal Edge[N+2, N+3], instead of converting from 0 to 1, is previously converted to 1 and stays at 1. Hence, the ISI detection unit 152 determines that the transition between the values of the sequence is too early according to detection value, i.e., under-damping has occurred. The state machine 154 is controlled by the determination result of the ISI detection unit 152 to output a state value to the equalizer 110 to adjust the equalization on the incoming data signal, such that the equalizer 110 increases a gain for high-frequency components relative to that for low-frequency components. Accordingly, ISI effects are effectively eliminated.

A method for clock data recovery for a clock data recovery circuit is further provided according to another embodiment of the present invention. The clock data recovery circuit includes an equalizer, a multi-phase clock generator, a sampling and check unit, a signal edge detection unit and an adjusting unit. The method includes steps of: performing an equalization on an incoming data signal by the equalizer; generating multiple clock signals and at least one pair of check signals by the multi-phase clock generator; sampling the incoming data signal according to the clock signals to obtain a sequence and checking whether the sequence matches a predetermined pattern by the sampling and check unit; when the sequence matches the predetermined pattern, controlling the sampling and check unit to correspondingly check a transition between values of the sequence two on two based on the pair of check signal to obtain a detection value by the signal edge detection unit; determining whether the transition between the value of the sequence is too early or too late according to the detection value, and controlling the equalizer to adjust the equalization on the incoming data signal according to the determination result by the adjusting unit.

Operation details of the above clock data recovery method are as disclosed in associated descriptions of the clock data recovery circuit 100, and shall be omitted herein.

With the descriptions of the above embodiments, it is demonstrated that, in a circuit and method for clock data recovery of the present invention, multiple clock signals and at least one pair of check signals are generated by a multi-phase clock generator to detect edges of an incoming data signal, and an equalization on an incoming data clock is adjusted according to a detection result to effectively eliminate ISI effects.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A circuit for clock data recovery, comprising:
an equalizer, for performing an equalization on an incoming data signal;
a multi-phase clock generator, for generating a plurality of clock signals and at least one pair of check signals;
a sampling and check unit, for sampling the incoming data signal according to the clock signals to obtain a sequence, and checking whether the sequence matches a predetermined pattern;
a signal edge detection unit, for controlling the sampling and check unit to correspondingly detect a transition between values of the sequence two on two based on the pair of check signals to obtain a detection value when the sequence matches the predetermined pattern; and
an adjusting unit, for determining whether the transition between the values of the sequence is too early or too late according to the detection value, and controlling the equalizer to adjust the equalization on the incoming data signal according to a determination result.

2. The circuit according to claim 1, wherein each pair of check signal comprise a first check signal and a second check signal, the signal edge detection unit further divides the first check signal into a K number of phases and controls the sampling and check unit to check and obtain that the value of the sequence converts at a Y^{th} phase of the first check signal, and the edge detection unit further divides the second check signal into a K number of phases and controls the sampling and check unit to check and obtain that the value of the sequence converts at a Y^{th} phase of the second check signal, where K and Y are positive integers.

3. The circuit according to claim 1, wherein the adjusting unit comprises:
an inter-symbol interference (ISI) detection unit, for determining whether the transition between the values of the sequence is too early or too late according to the detection value; and
a state machine, controlled by a determination result of the ISI detection unit to output a state value to the equalizer to adjust the equalization on the incoming data signal.

4. A method for clock data recovery, applied to a clock data recovery circuit, the clock data recovery circuit comprising an equalizer, a multi-phase clock generator, a sampling and check unit, a signal edge detection unit and an adjusting unit, the method comprising:
performing an equalization on an incoming data signal by the equalizer;
generating a plurality of clock signals and at least one pair of check signals by the multi-phase clock generator;
sampling the incoming data signal according to the clock signals to obtain a sequence, and checking whether the sequence matches a predetermined pattern by the sampling and check unit;
when the sequence matches the predetermined pattern, controlling the sampling and check unit to correspondingly detect a transition between values of the sequence two on two based on the pair of check signals to obtain a detection value by the signal edge detection unit; and
determining whether the transition between the values of the sequence is too early or too late according to the detection value, and controlling the equalizer to adjust the equalization on the incoming data signal according to a determination result by the adjusting unit.

5. The method according to claim 4, each pair of check signals comprising a first check signal and a second check signal, the method further comprising:
dividing the first check signal into a K number of phases and controlling the sampling and check unit to check and obtain that the value of the sequence converts at a Y^{th} phase of the first check signal by the signal edge detection circuit; and
dividing the second check signal into a K number of phases and controlling the sampling and check unit to check and obtain that the value of the sequence converts at a Y^{th} phase of the second check signal by the signal edge detection circuit;
wherein, K and Y are positive integers.

6. The method according to claim 4, the adjusting unit comprising an ISI detection unit and a state machine, the method further comprising:
determining whether the transition between the values of the sequence is too early or too late according to the detection value by the ISI detection unit; and
controlling the state machine by a determination result of the ISI detection unit to output a state value to the equalizer to adjust the equalization on the incoming data signal by the state machine.
